(19) United States
(12) Patent Application Publication
(10) Pub. No.: US 2011/0162033 A1
(43) Pub. Date: Jun. 30, 2011

(54) LOCATION BASED SECURITY OVER WIRELESS NETWORKS

(75) Inventors: Jason Wyatt Feinstein, Plam Harbor, FL (US); Kimberly Diane Kenna, Cary, NC (US); Yusuf A. Simonson, (US)

(73) Assignee: International Business Machines Corporation, Armonk, NY (US)

(21) Appl. No.: 12/647,681

(22) Filed: Dec. 28, 2009

(51) Int. Cl. G06F 17/00; G06F 15/173; G06F 15/16; G06F 9/445

(52) U.S. Cl. 726/1; 709/223; 709/224; 709/217; 717/178

(57) ABSTRACT

A method, system, and computer usable program product for location based security over wireless networks are provided in the illustrative embodiments. A location of a data processing system is determined based on information about a network. A security policy is selected based on the location. The security policy is applied to the data processing system such that the data processing system is configured in a security configuration for using the network while maintaining security according to the security policy.

### BACKGROUND OF THE INVENTION

1. Field of the Invention

The present invention relates generally to an improved data processing system, and in particular, to a computer implemented method for providing data security. Still more particularly, the present invention relates to a computer implemented method, system, and computer usable program code for providing location based security over wireless networks.

2. Description of the Related Art

Data is frequently exchanged between various data processing systems using one or more data networks. Some data networks may be regarded as public networks, such as wide area networks accessing the Internet. Other data networks may be private networks, such as local area networks, and virtual private networks (VPNs).

A data processing system situated in a public network may communicate with a data processing system situated in a private network through a variety of devices and applications. Such communications may cause an exchange of data between any combination of data processing systems in public and private networks.

Wireless networks are networks that allow data processing systems to communicate wirelessly using radio devices. At a given time and location, a data processing system may be able to access one or more wireless networks.

Security of the data, the systems the data resides on, and the networks where the systems operate, is a concern in data communications. Typically, security of a data processing system, contents thereof, and networks that the data processing system operates on is accomplished by some security mechanism. A user identifier (UID) and password authentication is a common method of accomplishing security objectives in data processing environments.

Security of data, data processing systems, and networks is also dependent upon the network where a data processing system may operate. For example, operating a data processing system in a particular network may expose the data processing system's contents to malicious use, whereas operating the data processing system in another network may not. Similarly, certain resources of one data processing system may be available to another data processing system while the second data processing system operates in a particular network, but not when the second data processing system operates in a different network.

Based on such factors and other security considerations, some networks may be considered more secure than other networks. Wireless networks allow data processing systems to be mobile and data processing systems can communicate using several wireless networks. Different wireless networks may offer differing degrees of security to data processing systems operating thereon.

### SUMMARY OF THE INVENTION

The illustrative embodiments provide a method, system, and computer usable program product for location based security over wireless networks. An embodiment of the invention determines a location of a data processing system based on information about a network. The embodiment selects a security policy based on the location. The embodiment applies the security policy such that the data processing system is configured in a security configuration for using the network while maintaining security according to the security policy.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a data processing system configuration in accordance with an illustrative embodiment;

FIG. 4 depicts a block diagram of an example configuration of a security application in accordance with an illustrative embodiment;

FIG. 5 depicts a flowchart of a process of enforcing location based security over wireless networks in accordance with an illustrative embodiment;

FIG. 5A depicts a flowchart of an example process usable in combination with the process of FIG. 5 in accordance with an illustrative embodiment;

FIG. 5B depicts a flowchart of another example process usable in combination with the process of FIG. 5 in accordance with an illustrative embodiment;

FIG. 5C depicts a flowchart of another example process usable in combination with the process of FIG. 5 in accordance with an illustrative embodiment;

FIG. 6 depicts a block diagram of a process of overriding a location based security in accordance with an illustrative embodiment;

FIG. 7 depicts a flowchart of a process of requesting a policy or policy update in accordance with an illustrative embodiment;

FIG. 8 depicts a flowchart of a process of sending policies and policy updates from a policy server in accordance with an illustrative embodiment; and

FIG. 9 depicts a flowchart of a process of handling notifications in accordance with an illustrative embodiment.

### DETAILED DESCRIPTION OF THE PREFERRED EMBODIMENT

The invention recognizes that a network generally has an associated geographical location. For example, one wireless network may be available on one floor of an office building and another wireless network may be available on another floor of the same office building. Similarly, one wireless network may be accessible within a secured lab environment at an office and another wireless network may be accessible at a local coffee shop.

A data processing system may use a wireless network to communicate with another data processing system on same or different network. Any device capable of using a wireless network for communication is considered a data processing system within the scope of the invention.

The invention recognizes that security configuration of the contents of a data processing system and that of other data processing systems in communication with the first data processing system may depend upon the location of the first data processing system. For example, when a data processing system is in a secured lab environment in an office that requires security badge based access, the data processing system may be reasonably assumed to be in a secured area and under secured control. Accordingly, the security configuration of the data processing system may be relaxed while the data processing system uses the designated wireless network in that secured area.

As another example, when the data processing system is located at a local coffee shop and communicating over the wireless network available there, the security configuration of the data processing system may be heightened while the data processing system uses the wireless network in that area. Relaxing the security configuration may allow the data processing system to access resources locally on the data processing system and over the wireless network without re-authentication, such as by re-entering a UID and password. Heightening the security configuration, on the other hand, may make certain resources off limits to the data processing system, and make certain other resources available only upon taking additional security measures, such as by re-entering a UID and password.

Some solutions for addressing the security needs in wireless networks presently exist. The invention recognizes that the presently available solutions for security over wireless networks suffer from certain drawbacks. For example, some location aware security solutions determine the security configuration to apply to a data processing system based on a determination made at a wireless network access point or at a remote server data processing system. In such solutions, the data processing system that is operating on the wireless network is itself passive recipient of the security configuration. In other words, the data processing system itself cannot choose a security configuration to enforce.

In certain other presently available solutions, the location determination is independent of the network on which a data processing system is operating. For example, the location in such solutions may be determined by global positioning system (GPS) coordinates or an identifier, such as a telephone number, associated with the data processing system. Such solutions require additional hardware and software in the data processing system to provide security.

As another example, certain solutions provide security configurations for categories of networks. For example, one security configuration may apply to secured networks and another may apply to unsecured networks. Such solutions do not offer the flexibility for addressing security issues when encountering previously unknown networks, or for handling different unsecured networks differently.

Furthermore, the invention recognizes that the presently available solutions for security over wireless networks do not provide a way of monitoring the movement of the data processing system within a wireless network or from one wireless network to another. The invention recognizes that monitoring the movement of a data processing system in this manner can be effective in controlling theft of assets, breach of secured spaces, and malicious use of data.

The illustrative embodiments used to describe the invention generally address and solve the above-described problems and other problems related to security in using wireless networks. The illustrative embodiments provide a method, computer usable program product, and data processing system for location based security over wireless networks.

As one example use, certain embodiments of the invention may use security policies to perform security related configurations of a data processing system. A security policy is a rule or specification for performing a configuration, sending an instruction, sending a message, or a combination thereof, for enforcing a security measure in a data processing system. Furthermore, a security policy's rule or specification for performing an action is dependent upon a location of the data processing system and on information describing one or more wireless networks present at that location.

An example of a security configuration may be blocking access to certain portions of a file system. As another example use, certain embodiments may use security policies to send security related instructions to an application, such as an operating system. An example of a security instruction may be an encryption command sent to the operating system to encrypt all or part of a hard drive. The examples of security configuration and security instructions are not intended to be limiting on the invention. An implementation may use these and other configurations and instruction in any combination with one another within the scope of the invention.

The illustrative embodiments are described with respect to certain documents, data, data structures, file systems, names, directories, and paths only as examples. Such descriptions are not intended to be limiting on the invention. For example, an illustrative embodiment described with respect to a 802.11 standard based wireless network may be used in a cellular data network in a similar manner within the scope of the invention.

Furthermore, the illustrative embodiments may be implemented with respect to any type of data processing system, data, data source, or access to a data source over a wireless data network. Any type of wireless service may provide a wireless network for an embodiment of the invention, either accessed by a data processing system or as a part of the data network used for communication by the data processing system, within the scope of the invention. A geographic information system (GIS) may be configured and used in conjunction with an embodiment to determine either a location associated with a given wireless network or a wireless network associated with a given location.

The illustrative embodiments are further described with respect to certain parameters, attributes, and configurations only as examples. Certain embodiments are described with respect to certain applications also only as examples. Such descriptions are not intended to be limiting on the invention. An embodiment of the invention may be implemented with respect to any type of application, such as, for example, any type of client application, server application, platform application, stand-alone application, or a combination thereof.

Application may further include data objects, code objects, encapsulated instructions, application fragments, services, and other types of resources available in a data processing environment. For example, Java® object, an Enterprise Java Bean (EJB®), a servlet, or an applet may be manifestations of an application with respect to which, within which, or using which, the invention may be implemented. (Java, EJB, and other Java related terminologies are registered trademarks of Sun Microsystems, Inc. in the United States and other countries.)

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, data structures, file systems, designs, architectures, layouts, schematics, and tools only as examples and are not limiting on the illustrative embodiments. Furthermore, the illustrative embodiments are described in some instances using particular software tools and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

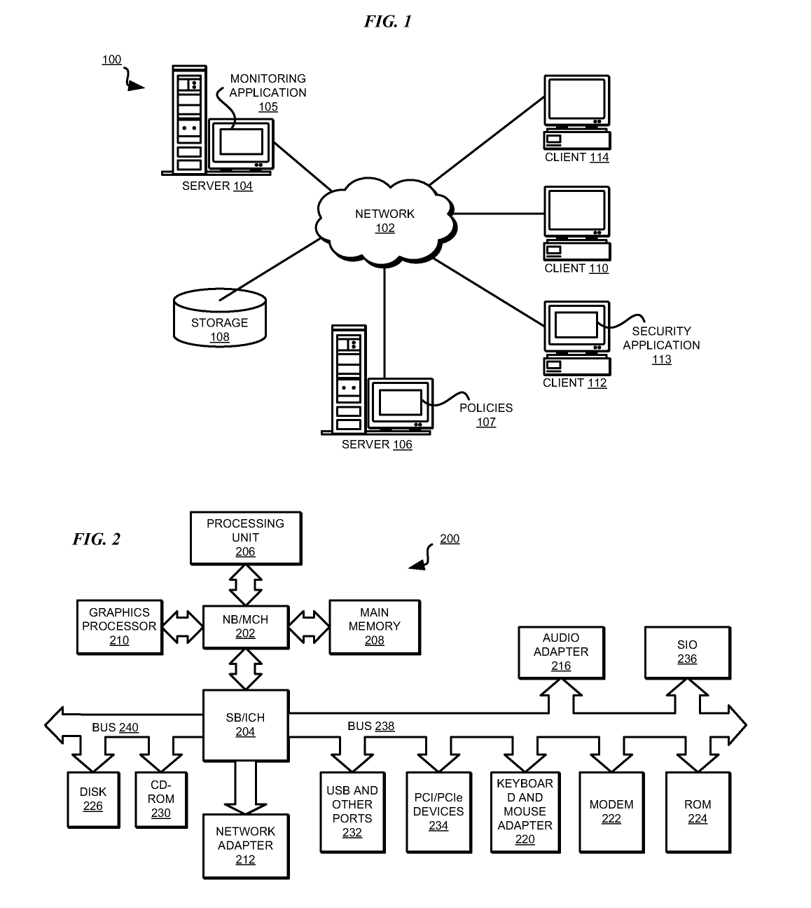

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include monitoring application 105. Monitoring application 105 may be any application operating to monitor location, connection to networks, geographical movement, or a combination thereof, of a data processing system. Server 106 may include policies 107. Policies 107 may be a policy repository or a policy server—a server application for serving policies. A policy in policies 107 may be a security policy. Client 112 may include security application 113. Security application 113 may be an application or a component thereof, capable of providing security configuration, security instructions, or a combination thereof according to an embodiment of the invention.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

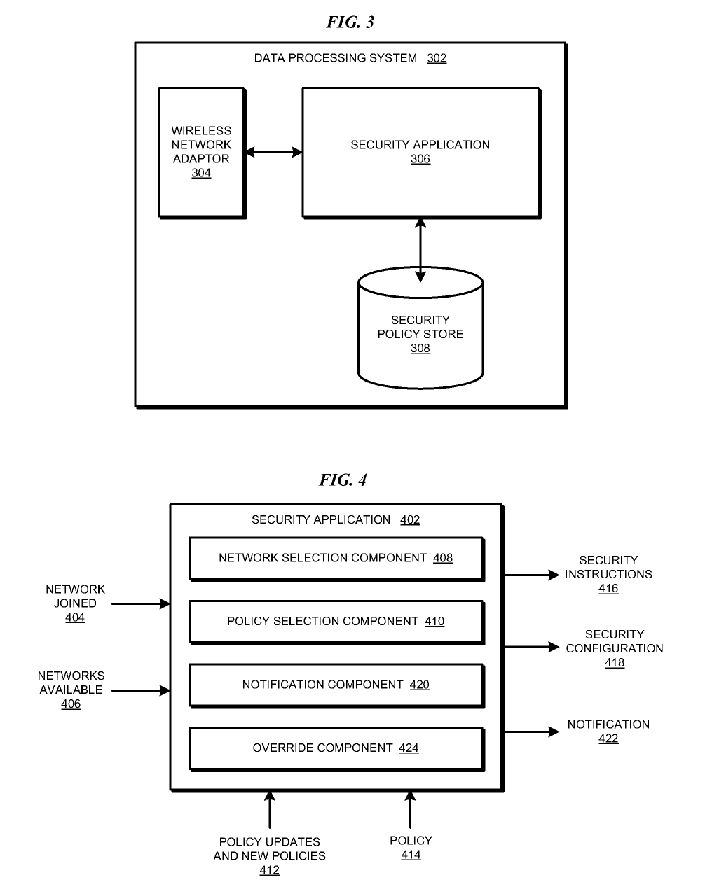

With reference to FIG. 3, this figure depicts a block diagram of a data processing system configuration in accordance with an illustrative embodiment. Data processing system 302 may be similar to client 112 in FIG. 1. Wireless network adapter 304 may be a type of network adapter 212 in FIG. 2.

Security application 306 executing in data processing system 302 may be an application or a component thereof in accordance with the illustrative embodiment. Security application 306 operates to perform security configurations, send and receive security instructions, send and receive notifications, or a combination thereof. Security application 306 may also communicate with other applications on data processing system 302, such as the operating system of data processing system 302. Security application 306 may also communicate with applications on other data processing systems, such as monitoring application 105 on server 104 in FIG. 1, or a policies server on server 106 in FIG. 1.

Security policies store 308 may be a repository of security policies. In one embodiment, security policies store 308 may provide the security policies used by security application 306 in configuring location based security over wireless networks for data processing system 302.

In another embodiment, security policies store 308 may serve as the temporary, off-line, or backup repository of security policies downloaded from a policies server. For example, when network connectivity exists, security application may receive a security policy to apply from a policies server. When network connectivity is unusable, for example, when data processing system 302 or a policy server is off-line, security application 306 may use a security policy from security policy store 308.

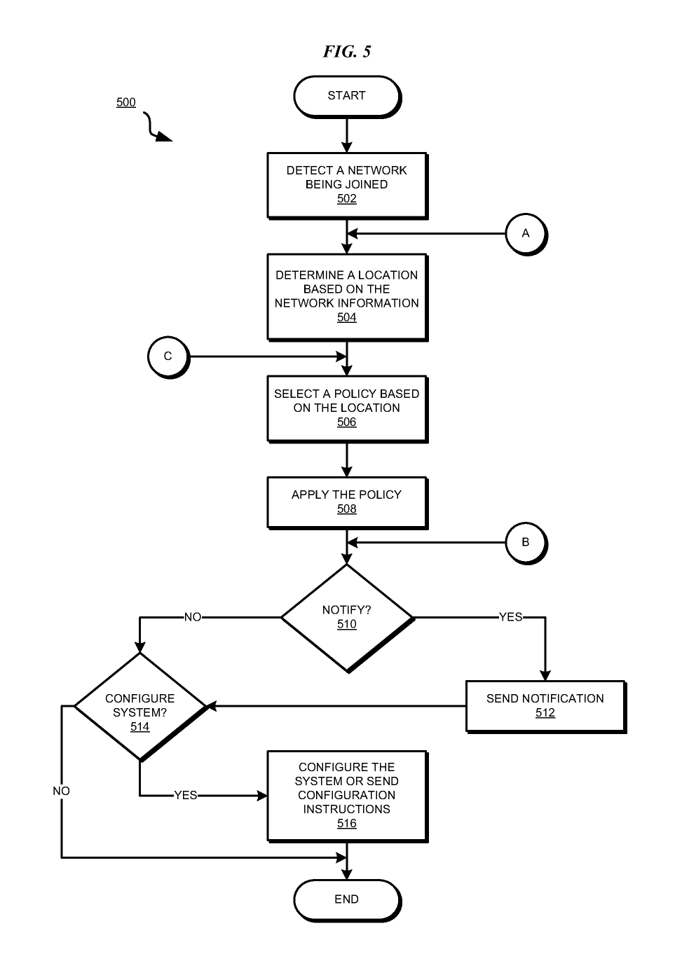

With reference to FIG. 4, this figure depicts a block diagram of an example configuration of a security application in accordance with an illustrative embodiment. Security application 402 may be similar to security application 306 in FIG. 3.

Security application 402 may receive information 404. Information 404 may describe a wireless network that a data processing system of security application 402 may have joined for using in data communications. An embodiment of security application 402 may also receive information 406. Information 406 may describe one or more wireless networks that may be accessible to the data processing system of security application 402 but which the data processing system has not joined for use in data communications. Joining a network is logging into or otherwise communicating with the network such that data communications can be carried out over the network.

Network selection component 408 may allows security application 402 to select a network for joining. For example, in one embodiment, network selection component 408 may select a network based on available networks information 406 such that the selected network allows the data processing system to operate in the least restrictive manner as compared to other available networks.

As an example, in another embodiment, network selection component 408 may select a network based on available networks information 406 such that the selected network allows the data processing system to operate in the most restrictive manner as compared to other available networks. Such an embodiment may be useful when, for example, the available networks are all previously unknown networks, such as when the data processing system is operated in a new city and is suspected of having been stolen. Network selection component 408 may select a network in any manner suitable for a particular implementation, such as by applying a security policy, within the scope of the invention.

Policy selection component 410 may select a suitable policy to apply under a given location circumstance and the wireless networks operating in that given location. For example, an example policy may be to select the most secured known networks from the available networks operating in a location when possible. Such a policy may select the network that offers the most privileges, and consequently the least restrictions to the data processing system's operations.

Another example policy may be to time out an automatic authentication on a joined network sooner when all other available networks in a given location are previously unknown as compared to when the other available networks in the location are familiar networks. Such a policy may be useful in mitigating data theft when the data processing system is operating in unknown locations and possibly spoofing the characteristics of a known network.

Another example policy may be to select the progressively lesser privileged networks operating in a location when the performance on the most secured and privileged network falls below a threshold. Such a policy may be useful when performance of the data processing system is more important that the restrictions on the operations of the system, such as on a mobile phone device during a voice call.

Another example policy may trigger a notification or a logging message to a server when the signal from a joined wireless network at a location drops below a threshold. Such a policy may be useful in detecting that the data processing system is about to leave the location of the wireless network. A converse policy may be useful in detecting when a data processing system is about to enter a location of a particular wireless network.

Another example policy may trigger a lock down of the data processing system leaves a location. Such a policy may be useful in preventing removal of secured data processing systems from secured areas and generally in preventing loss of assets. As an example, whether the data processing system has left the perimeter of an area can be determined in one example way by detecting that the signal from a wireless network in the secured area has dropped below a threshold.

Another policy may trigger a lock-out, re-authentication, automatic re-configuration, notification, or a combination thereof, when one joined network is dropped and another network is joined at a given location. Such a policy may be useful when the data processing system travels from one location to another and switches networks with different security characteristics.

Another policy may cause the security configuration corresponding to a joined network at one location to persist in the data processing system for a predetermined period even when the signal from the joined network is lost at another location. Such a policy may be useful in avoiding work disruption when the data processing system remains in the location of the network but travels through an area that is a wireless dead zone in that location.

These examples illustrate how security policies may be implemented by using the information of a detected network to determine a location, or by using location information to detect networks in that location. In one embodiment, a security policy may use the features of a local or remote GIS to determine a location using the information of a network, and vice versa. These examples of policies are described only for the clarity of the illustrative embodiments and are not intended to be limiting on the invention. Any criteria suitable for a particular implementation may be designed into a policy without limitation and within the scope of the invention.

Security application 402 may receive, either passively or upon request, policy updates and new policies 412 from a policy server. Security application 402 may also receive or retrieve policy 414, which may be a policy selected by policy selection component 410. In one embodiment, policy 414 may be retrieved from a local policy store, such as security policy store 308 in FIG. 3. In another embodiment, policy 414 may be received from a policy server, such as server 106 in FIG. 1.

Security application 402 may apply the policy selected by policy selection component 410. As a result of applying the policy, security application 402 may generate security instructions 416, perform security configuration 418, or both.

Notification component 420 may send notification 422 when certain events occur. Notification 422 may be, for example, a message transmitted to a remote data processing system over a data network or message presented in the local data processing system. For example, a notification may be generated to a remote server when the data processing system of security application 402 joins a network in a previously unknown location. Another example notification may page security personnel if the data processing system is about to exit the location of a network. Another example notification may display a message on the data processing system of security application 402 when networks are about to be switched and privileges affected as the location of the data processing system is changed.

These examples of notifications are described only for the clarity of the illustrative embodiments and are not intended to be limiting on the invention. Any notification suitable for a particular implementation may be configured in notification component 420 without limitation and within the scope of the invention.

Furthermore, notification 422 may be presented in any manner suitable to a particular implementation. For example, notification 422 may be transmitted, recorded, logged, displayed, announced, indicated, or otherwise communicated to one or more data processing systems, devices, or personnel.

Override component 424 may allow overriding a security configuration upon detecting an override event. An override event may be an event that may indicate that a security configuration may be overridden, such as to perform a function or to correct an error.

An override event may result from the success or failure of the application of a policy. For example, in the event that a policy causes inconsistent configuration in the data processing system of security application 402, override component 424 may allow an administrator to reset the security configuration to a default configuration.

As another example, override component 424 may also allow an application in the data processing system to override a security configuration to accomplish a privileged task. For example, if a policy is configured to block out certain portions of a file system, the operating system may still be able to override the block-out and access those portions of the file system when the policy is applied. Override component 424 may be configured in these example ways and in other ways as may be suitable for a particular implementation within the scope of the invention.

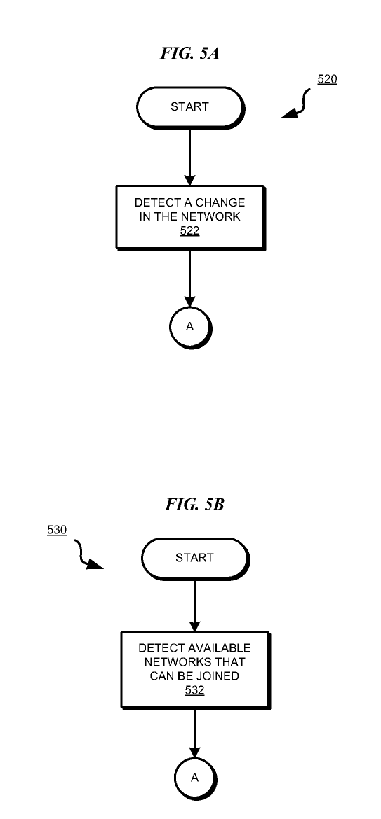

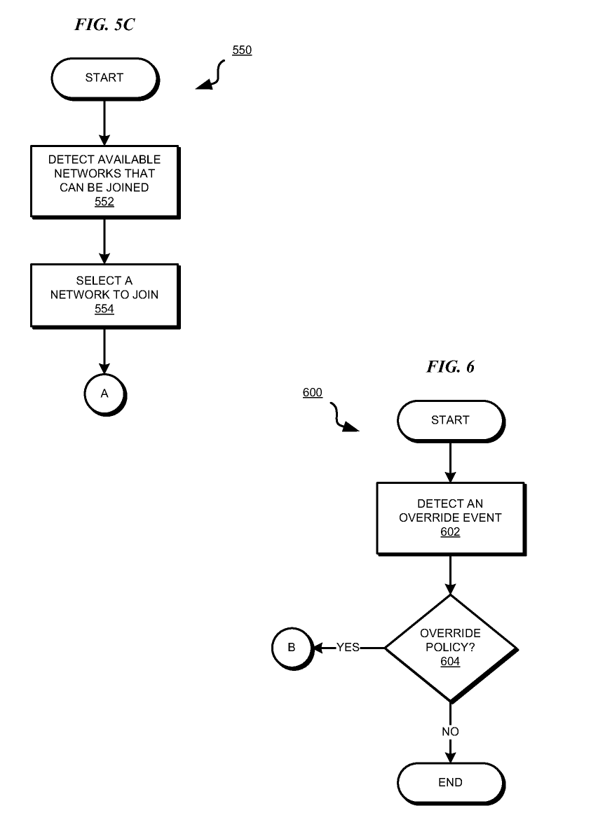

With reference to FIG. 5, this figure depicts a flowchart of a process of enforcing location based security over wireless networks in accordance with an illustrative embodiment. Process 500 may be implemented in a security application, such as security application 402 in FIG. 4.

Process 500 begins by detecting a network being joined (step 502). Process 500 determines a location of the data processing system where process 500 is executing based on the information of step 502 (step 504).

Process 500 selects a policy based on the location determined in step 504 (step 506). Process 500 applies the selected policy (step 508). In one embodiment, process 500 may select and apply more than one policy in steps 506 and 508.

Process 500 determines is the information of the network being joined from step 502, or the location from step 504, or the application of the selected policy in step 508 trigger a notification (step 510). If a notification is triggered (“YES” path of step 510), process 500 generates and sends a notification (step 512).

If a notification is not triggered (“NO” path of step 510), process 500 determines whether to configure the data processing system according to the policy (step 514). If the data processing system should be configured (“YES” path of step 514), process 500 either performs a security configuration or sends configuration instructions, such as to the operating system or a component thereof (step 516). Process 500 ends thereafter.

Portions of process 500 may be usable in combination with other steps when certain events are detected. For example, process 520 in FIG. 5A begins by detecting a change in the network (step 522).

For example, the data processing system, where processes 500 and 520 may be executing, may move from one location to another causing a change in the wireless networks over which the data processing system communicates. Process 520 detects the change in networks in this or other similar circumstances in step 522. Following step 522, process 520 proceeds to the entry point “A” as shown in process 500 in FIG. 5 and proceeds as described in process 500 thereafter.

As another example, process 530 in FIG. 5B begins by detecting available networks that can be joined (step 532). For example, the data processing system, where processes 500 and 530 may be executing, may be in a location where several wireless networks may be available. Process 530 detects the presence of such networks in step 532. Following step 532, process 530 proceeds to the entry point “A” as shown in process 500 in FIG. 5 and proceeds as described in process 500 thereafter.

In one embodiment, as depicted in FIG. 5C, process 550 may be a modification of process 530 of FIG. 5B. Process 550 may begin by detecting available networks that can be joined (step 552). Process 550 may select a network to join (step 554). As an example, process 550 may select a network in step 554 by application of a policy or by employing another logic suitable to a particular implementation. Following step 554, process 550 proceeds to the entry point “A” as shown in process 500 in FIG. 5 and proceeds as described in process 500 thereafter.

With reference to FIG. 6, this figure depicts a block diagram of a process of overriding a location based security in accordance with an illustrative embodiment. Process 600 may be implemented in a security application, such as in override component 424 of security application 402 in FIG. 4.

Process 600 begins by detecting an override event (step 602). Process 600 determines whether to override a policy based security configuration to address the event of step 602 (step 604). If the configuration should be overridden (“YES” path of step 604), process 600 proceeds to the entry point “B” as shown in process 500 in FIG. 5 and proceeds as described in process 500 thereafter. If the configuration should not be overridden (“NO” path of step 604), process 600 ends thereafter.

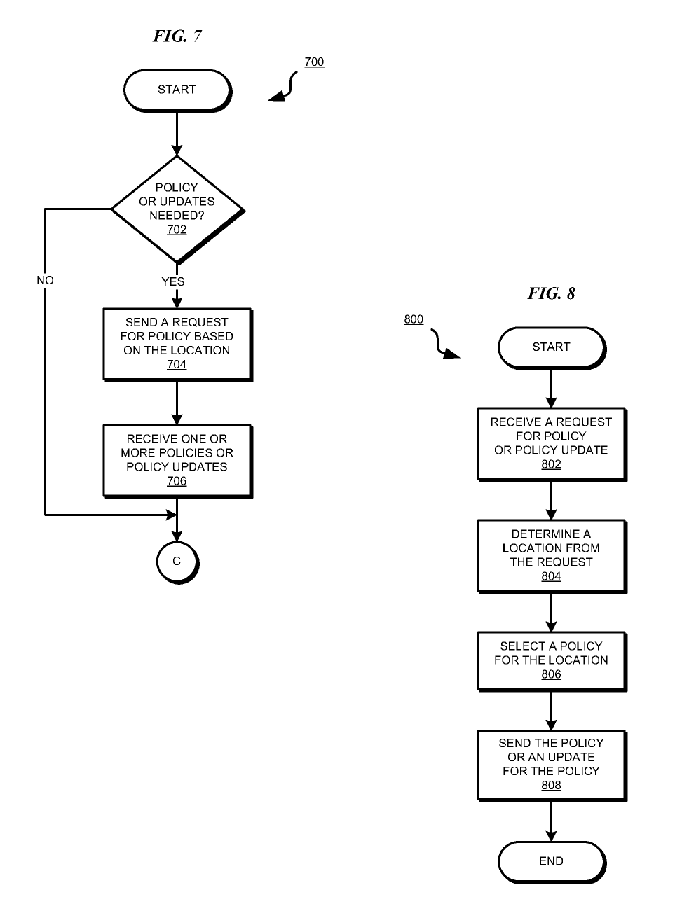

With reference to FIG. 7, this figure depicts a flowchart of a process of requesting a policy or policy update in accordance with an illustrative embodiment. Process 700 may be implemented in a security application, such as security application 402 in FIG. 4.

Process 700 begins by determining whether a policy or a policy update is needed, such as to enforce location based security over wireless networks (step 702). If process 700 determines that a policy or a policy update is needed (“YES” path of step 702), process 700 sends a request for a policy or policy update (step 704). The request of step 704 is based on the location of the data processing system where process 700 may be executing. For example, the location used in step 704 may be the location determined in step 504 in process 500 of FIG. 5.

Process 700 receives one or more policies or policy updates (step 706). Process 700 ends thereafter.

The request of step 704 may be sent to, and the response of step 706 may be received from a remote data processing system, such as a policy server, over a data network. In one embodiment, the communication with the policy server may be allowed to occur over a default network while blocking other activities using that default network. Once a policy has been applied for a wireless network, the wireless network under the security configuration of the policy may be used for further activities.

This example describes a way of downloading and applying a policy or update only as one possible implementation and is not intended to be limiting on the invention. An implementation may maintain security during download of policies and allow subsequent communication in other ways within the scope of the invention. For example, an implementation may periodically download policies and updates while the data processing system is operating under a security configuration on a particular network. The implementation may then apply a downloaded policy when the location of the data processing system changes.

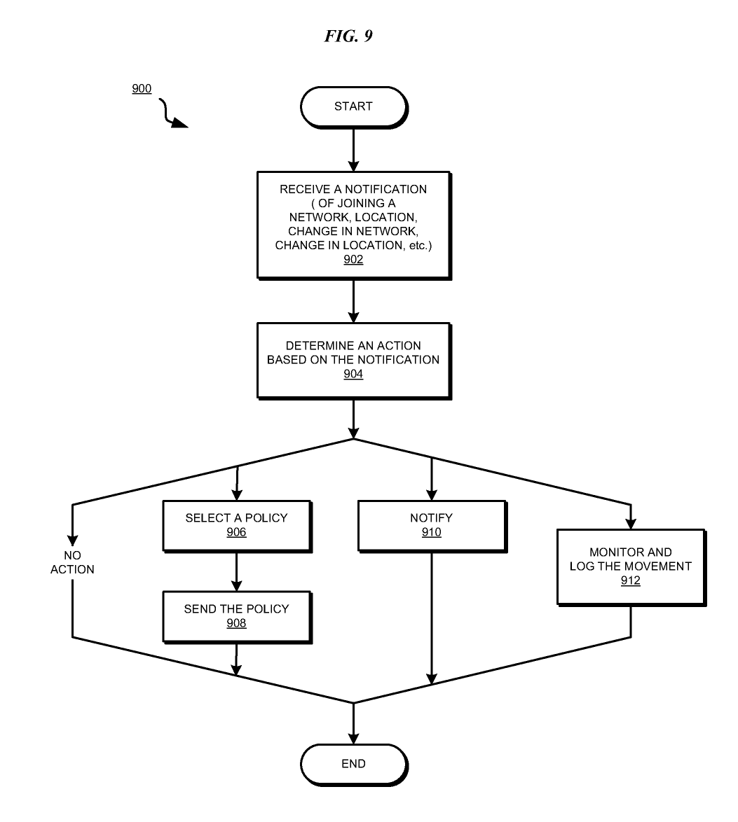

With reference to FIG. 8, this figure depicts a flowchart of a process of sending policies and policy updates from a policy server in accordance with an illustrative embodiment. Process 800 may be implemented in a policy server, such as server 106 in FIG. 1.

Process 800 begins by receiving a request for policy or policy update (step 802). Process 800 determines a location from the request (step 804).

In one embodiment, process 800 may be implemented with alternate steps 802 and 804. In such an embodiment, process 800 may poll a data processing system in step 802 and collect location information from the polling in step 804.

Process 800 selects a policy for the location determined in step 804 (step 806). Process 800 sends the selected policy or an update for the selected policy (step 808). Process 800 ends thereafter.

With reference to FIG. 9, this figure depicts a flowchart of a process of handling notifications in accordance with an illustrative embodiment. Process 900 may be implemented in a monitoring server, such as server 104 with monitoring application 105 in FIG. 1.

Process 900 begins by receiving a notification (step 902). For example, the notification may be of joining a network, about a location of a network, a change in network, or a change in the location of a data processing system. Of course, a notification may include information other than the information of these examples without departing the scope of the invention.

Process 900 determines an action based on the notification (step 904). Only as examples, FIG. 9 depicts a few types of actions that process 900 may take based on the notification of step 902.

For example, process 900 may do nothing with the notification. This situation may arise when the notifications are routine valid responses to heartbeat signals from the monitoring server to the monitored data processing system, such as client 112 in FIG. 1. Process 900 may end thereafter or repeat.

As another example, process 900 may select a policy in response to the notification (step 906). Process 900 may send the policy to the monitored data processing system (step 908). Process 900 may end thereafter or repeat.

As another example, process 900 may notify, such as by paging, texting, or emailing a person or system (step 910). Process 900 may end thereafter or repeat.

As another example, process 900 may monitor the data processing system and log the movement of the data processing system based on the notification (step 912). Process 900 may end thereafter or repeat.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for location based security over wireless networks. Using the embodiments of the invention, a number of security configurations can be applied to a given combination of network, data processing system, workload on the data processing system, data on the data processing system, and other factors in a data processing environment.

The embodiments of the invention provide flexible security configurations that can be changed, updated, or overridden as needed. The embodiments of the invention further provide security mechanism that does not require additional hardware and can work in existing hardware-software configuration of most existing data processing systems.

The embodiments of the invention can collaborate with existing monitoring applications. The embodiments can also collaborate with existing policy infrastructures that may be in use in certain data processing environments.

The invention can take the form of an entirely software embodiment, or an embodiment containing both hardware and software elements. In a preferred embodiment, the invention is implemented in software or program code, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for location based security over wireless networks, the computer implemented method comprising:
determining a location of a data processing system based on information about a network operating in the location, the network being a wireless network in the wireless networks;
selecting a security policy based on the location and the network; and
applying the security policy such that the data processing system is configured in a security configuration to use the network while maintaining security according to the security policy.

2. The computer implemented method of claim 1, further comprising:
detecting a plurality of available networks; and
selecting an available network from the plurality of available networks, the selected available network forming the network.

3. The computer implemented method of claim 1, further comprising:
detecting a change in the network, wherein the determining the location is based on information about the change in the network, and wherein the detecting the change causes selecting a second security policy.

4. The computer implemented method of claim 3, wherein the change in the network is one of (i) a change in a signal strength of the network, and (ii) the data processing system switching from the network to a second network.

5. The computer implemented method of claim 1, further comprising:
detecting an override event; and
overriding the security configuration of the data processing system.

6. The computer implemented method of claim 1, further comprising:
receiving one of (i) the security policy, and (ii) an update for the security policy, wherein the update is applied to the security policy before applying the security policy.

7. The computer implemented method of claim 6, wherein the receiving is responsive to a request based on the location.

8. The computer implemented method of claim 1, further comprising:
sending a notification, wherein the notification is responsive to one of (i) location of the data processing system, and (ii) a change in the network; and
using the notification to monitor a change of location of the data processing system.

9. The computer implemented method of claim 1, wherein applying the security policy makes a resource on the data processing system inaccessible.

10. The computer implemented method of claim 1, further comprising:
receiving at a policy server the location of the data processing system;
selecting based on the location one of (i) the security policy, and (ii) an update for the security policy, forming a selection; and
sending the selection.

11. The computer implemented method of claim 10, wherein the receiving the location is responsive to one of (i) receiving a request from the data processing system, and (ii) polling the data processing system.

12. A computer usable program product comprising a computer usable storage medium including computer usable code for location based security over wireless networks, the computer usable code comprising:
computer usable code for determining a location of a data processing system based on information about a network operating in the location, the network being a wireless network in the wireless networks;
computer usable code for selecting a security policy based on the location and the network; and
computer usable code for applying the security policy such that the data processing system is configured in a security configuration to use the network while maintaining security according to the security policy.

13. The computer usable program product of claim 12, further comprising:
computer usable code for detecting a plurality of available networks; and
computer usable code for selecting an available network from the plurality of available networks, the selected available network forming the network.

14. The computer usable program product of claim 12, further comprising:
computer usable code for detecting a change in the network, wherein the determining the location is based on information about the change in the network, and wherein the detecting the change causes selecting a second security policy.

15. The computer usable program product of claim 12, further comprising:
computer usable code for detecting an override event; and
computer usable code for overriding the security configuration of the data processing system.

16. The computer usable program product of claim 12, further comprising:
computer usable code for receiving one of (i) the security policy, and (ii) an update for the security policy, wherein the update is applied to the security policy before applying the security policy, wherein the receiving is responsive to a request based on the location.

17. The computer usable program product of claim 12, further comprising:
computer usable code for receiving at a policy server the location of the data processing system;
computer usable code for selecting based on the location one of (i) the security policy, and (ii) an update for the security policy, forming a selection; and
computer usable code for sending the selection.

18. The computer usable program product of claim 12, wherein the computer usable code is stored in a computer readable storage medium in a data processing system, and wherein the computer usable code is transferred over a network from a remote data processing system.

19. The computer usable program product of claim 12, wherein the computer usable code is stored in a computer readable storage medium in a server data processing system, and wherein the computer usable code is downloaded over a network to a remote data processing system for use in a computer readable storage medium associated with the remote data processing system.

20. A data processing system for location based security over wireless networks, the data processing system comprising:
a storage device including a storage medium, wherein the storage device stores computer usable program code; and
a processor, wherein the processor executes the computer usable program code, and wherein the computer usable program code comprises:
computer usable code for determining a location of the data processing system based on information about a network operating in the location, the network being a wireless network in the wireless networks;
computer usable code for selecting a security policy based on the location and the network; and
computer usable code for applying the security policy such that the data processing system is configured in a security configuration to use the network while maintaining security according to the security policy.
